(19) United States
(12) Patent Application Publication
(10) Pub. No.: US 2019/0299554 A1
(43) Pub. Date: Oct. 3, 2019

(54) KNIFE FOR BEAD APEX MANUFACTURING HAVING A SERRATED BLADE

(71) Applicant: Bartell Machinery Systems, L.L.C., Rome, NY (US)

(72) Inventors: John Robert Russo, II, Marcy, NY (US); James M. Hovey, Barneveld, NY (US)

(73) Assignee: Bartell Machinery Systems, L.L.C., Rome, NY (US)

(21) Appl. No.: 16/367,804

(22) Filed: Mar. 28, 2019

Related U.S. Application Data
(60) Provisional application No. 62/650,840, filed on Mar. 30, 2018.

(51) Int. Cl. B29D 30/48; B60C 15/06

(52) U.S. Cl. CPC B29D 30/48; B29D 2030/481; B60C 15/0603

(57) ABSTRACT

A knife for cutting a bead apex for a vehicle tire may include a blade having a first face with a first surface, a cutting edge located at an end of the first surface and positioned for engagement with the bead apex, and a plurality of serrations extending from the first surface of the blade.

### RELATED APPLICATIONS

This application claims the benefit of U.S. Provisional Patent Application No. 62/650,840, filed Mar. 30, 2018, which is hereby incorporated by reference in its entirety.

### BACKGROUND

The present embodiments relate generally to systems and methods for cutting and handling a bead apex, such as one applied to a bead ring, in an improved manner.

Many types of vehicular tires include beads surrounding the openings that engage the wheel rim. In general, beads comprise a wire coil in the nature of a hoop formed by winding multiple turns of a coated wire on a suitable bead forming apparatus. The bead may be made up of multiple, radially and axially arranged turns of a single wire or, in so-called weftless beads, of radially stacked layers of a flat ribbon including a plurality of side-by-side wires.

Techniques have been used for applying a bead apex to the peripheral surface of a bead ring. In general, the bead apex is formed by extrusion of a material to a relatively thin shape having a generally triangular cross-section. The extruded bead apex then is maneuvered and applied to the peripheral surface of a bead ring. Once the bead apex is fully formed (e.g., extruded), it is cut at an appropriate point, and then its two ends coupled via a butt splice at a location adjacent to the outer periphery of the bead ring.

A common problem with the technique described above is that air may become trapped at the butt splice between the two ends of the bead apex, which may compromise the strength and durability of the butt splice. The result may be reduced manufacturing efficiency due to scrap parts and/or increased time spent correcting the issue. More seriously, if the trapped air goes undetected, it may result in a faulty vehicle tire.

### BRIEF SUMMARY

One general aspect of the present disclosure includes a knife for cutting a bead apex for a vehicle tire, the knife including: a blade having a first face with a first surface; a cutting edge located at an end of the first surface and positioned for engagement with the bead apex; and a plurality of serrations extending from the first surface of the blade.

Another general aspect includes a method including: placing a bead apex on a cutting surface for communication with a blade of a knife, the blade having a first face with a first surface, a cutting edge located at an end of the first surface and positioned for engagement with the bead apex, and a plurality of serrations extending from the first surface of the blade; and cutting the bead apex with the knife.

Another general aspect includes a vehicle tire, including: an annular bead ring; and a bead apex engaged with a peripheral surface of the annular bead ring, where the bead apex includes a first edge with a first splice surface and a second edge with a second splice surface, where the first splice surface and the second splice surface are coupled at a splice region, and where a plurality of grooves extends through at least one of the first splice surface and the second splice surface to form a plurality of channels that extend through the splice region.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic perspective view of selected components of a system for gripping and handling a bead apex, with upper and lower jaws in open states.

FIG. 2 is a perspective view of the system of FIG. 1 with the lower jaw in a closed state.

FIGS. 3-4 are, respectively, perspective and side views of the system of FIGS. 1-2 with the upper and lower jaws in a closed state, and with a plurality of grippers in retracted states.

FIGS. 5-6 are, respectively, perspective and side views of the system of FIGS. 1-2 with the upper and lower jaws in a closed state, and with a plurality of grippers in extended states.

FIGS. 7A-7B are perspective and side views, respectively, depicting features of an exemplary gripper.

FIG. 8 is a perspective view of additional components of a system for gripping and handling a bead apex.

FIG. 9 is a front perspective view of a knife for cutting an extruded strip of material to form a bead apex.

FIG. 10 is a rear perspective view of the knife of FIG. 9.

FIG. 11 is a perspective view of a blade for the knife of FIGS. 9-10.

FIG. 12 is a side view of the blade of FIG. 11.

FIG. 13 is a perspective sectional view of a bead apex with grooves.

FIGS. 14a-14c are cross-sectional top views showing embodiments of a knife blade with serrations for cutting a grooved bead apex.

FIG. 15 is a front view of a bead with a bead apex secured to its outer perimeter.

FIGS. 16A-B are photographs showing a strip of material cut with a serrated knife in accordance with the present embodiments.

### DETAILED DESCRIPTION

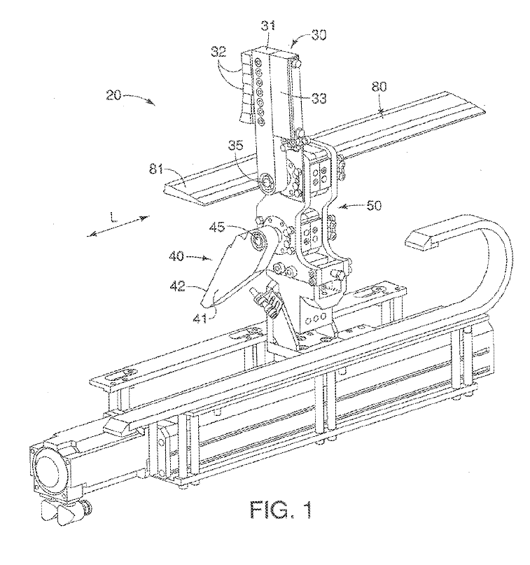

Referring to the drawings, and specifically FIGS. 1-8, a system 20 for gripping and handling an exemplary bead apex 80 is shown and described. The system 20 comprises an upper jaw 30 and a lower jaw 40, which selectively grip and handle the bead apex 80 as described further below.

The upper jaw 30 generally comprises an elongated main body 31, a plurality of grippers 32, and an actuation housing 33, as shown in various views and stages between FIGS. 1-6. The lower jaw 40 generally comprises an elongated main body 41 and an engaging surface 42.

The upper and lower jaws 30 and 40 are coupled to a frame 50. The frame 50 may comprise any suitable shape. In this non-limiting example, the frame 50 is generally vertically oriented relative to the ground, but other configurations are possible. The upper and lower jaws 30 and 40 are rotatable with respect to the frame 50 about pivot points 35 and 45, respectively. A suitable actuation mechanism may be used to effect rotation of the upper and lower jaws 30 and 40 about their respective pivot points 35 and 45.

Referring to FIG. 1, both the upper and lower jaws 30 and 40 are shown in open states, in which they are each spaced apart from an axis L defined by a pathway of the bead apex 80. The upper jaw 30 is depicted as being rotated about 90 degrees above the axis L in the open state, while the lower jaw 40 is depicted as being rotated about 40 to about 70 degrees below the axis L in the open state, but it will be appreciated that either of the jaws 30 and 40 may be rotated greater or lesser amounts with respect to the axis L in their respective open states.

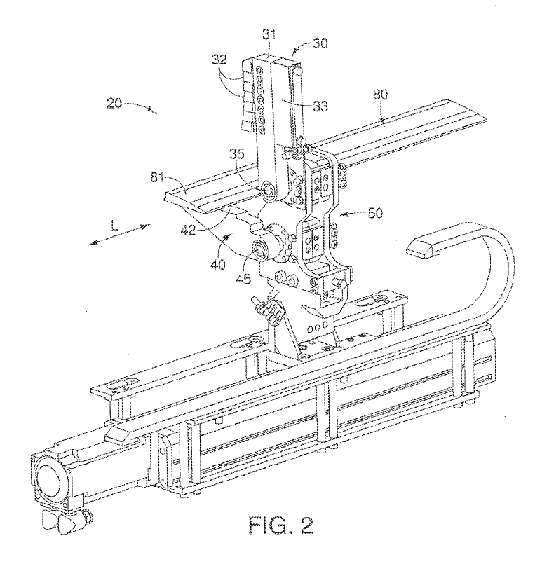

Referring to FIG. 2, the lower jaw 40 is shown in a closed state, in which it is rotated circumferentially upward, about the pivot point 45, such that the lower jaw 40 is substantially adjacent to a pathway of the axis L defined by the bead apex 80. In one embodiment, the engaging surface 42 of the lower jaw 40 may engage the bead apex 80 when the lower jaw 40 is in the closed state.

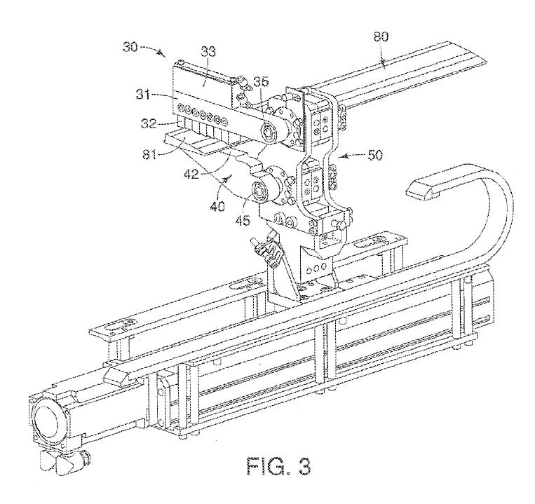

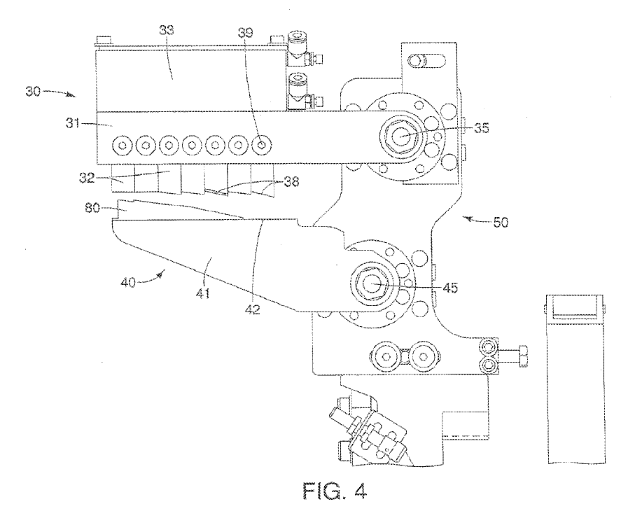

Referring to FIGS. 3-4, the upper jaw 40 is shown in a closed state, in which it rotated circumferentially downward, about the pivot point 35, such that the elongated main body 31 of the upper jaw 30 is substantially adjacent to a pathway of the axis L defined by the bead apex 80. In one embodiment, the elongated main body 31 is positioned slightly above the pathway of the bead apex 80, as best seen in FIG. 4.

In the state of FIGS. 3-4, the plurality of grippers 32 of the upper jaw 30 are shown in a retracted state, in which the plurality of grippers 32 are positioned upward, i.e., more towards the elongated main body 31 and further from the pathway of the bead apex 80. In the retracted state, the plurality of grippers 32 do not engage the bead apex 80, as shown in FIG. 4.

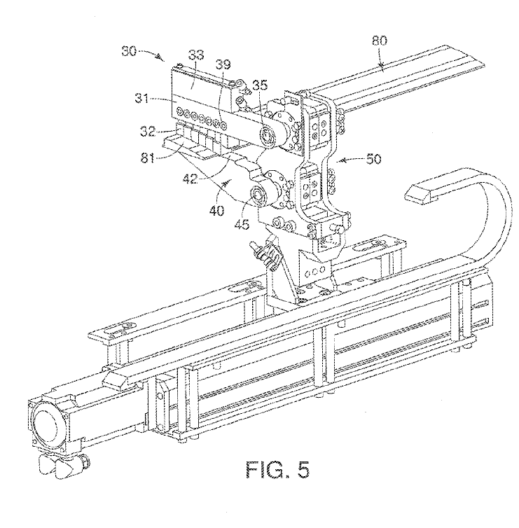

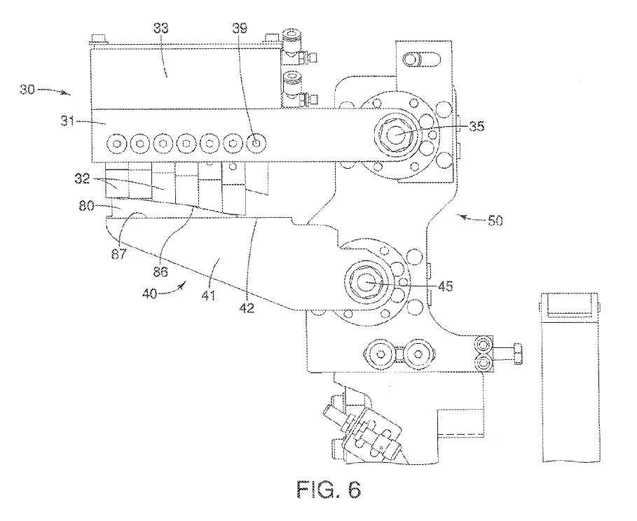

Referring to FIGS. 5-6, selected ones of the plurality of grippers 32 of the upper jaw 30 are shown in an extended state, in which selected ones of the plurality of grippers 32 are positioned downward, i.e., closer to the pathway of the bead apex 80. The selected ones of the plurality of grippers 32 may be moved from the retracted state of FIGS. 3-4 to the extended state of FIGS. 5-6 using suitable actuation mechanisms, such as at least one pneumatic cylinder housed within the actuation housing 33.

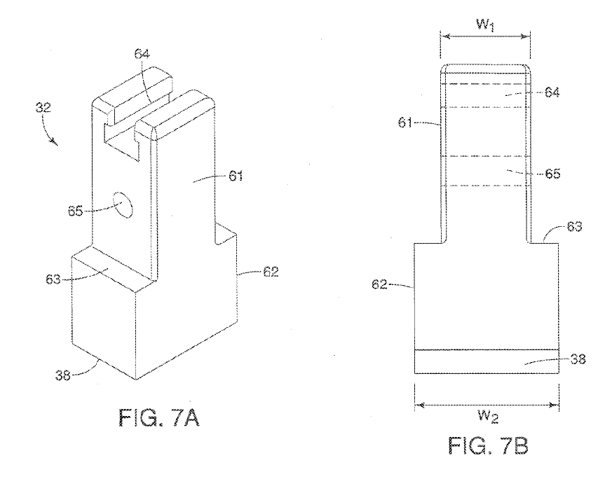

Referring to FIGS. 7A-7B, further features of an exemplary gripper 32 are shown and described. The exemplary gripper 32 comprises a first region 61 having a first width w₁ and a second region 62 having a second width w₂, where the second width w₂ is greater than the first width w₁, and a stepped region 63 separates the first and second regions 61 and 62. In the retracted state, the stepped region 63 abuts the elongated main body 31, thus keeping the second region 62 generally outside of the elongated main body 31, as depicted in FIG. 4. In the extended state, the stepped region 63 extends away from the elongated main body 31 to allow the tapered end surface 38 of the second region 62 to engage the bead apex 80, as depicted in FIG. 6.

The first region 61 is generally disposed within the elongated main body 31, and comprises a notch 64 and a bore 65, as shown in FIGS. 7A-7B. The notch 64 is coupled to a linkage, which in turn may be operatively coupled to the actuation mechanism, such as a pneumatic cylinder.

The bore 65 formed in each of the grippers 32 aligns with a blocking element 39, such as a movable screw selectively extending through the elongated main body 31, as depicted in FIGS. 4-6. When the blocking element 39 is selectively advanced by a user, the blocking element 39 may enter into the bore 65 of the respective gripper 32, thereby inhibiting movement of the particular gripper 32 from the retracted state to the extended state, notwithstanding actuation of the actuation mechanism. In the non-limiting example of FIG. 6, only the blocking element 39 on the right end has been deployed to block movement of the gripper 32 on the right end.

In one embodiment, one actuation mechanism, e.g., one pneumatic cylinder, is provided within the actuation housing 33, and is operatively coupled to each of the plurality of grippers 32, for example, using a manifold. Accordingly, when a single cylinder or other mechanism is actuated, each of the plurality of grippers 32 may be simultaneously actuated to move from the retracted to extended states, unless the blocking element 39 has been selectively deployed in advance.

In an alternative embodiment, multiple different actuation mechanisms may be provided within the actuation housing 33, e.g., one pneumatic cylinder per each gripper 32. In this embodiment, different actuations mechanisms may provide different pressures to different grippers 32. For example, it may be advantageous to provide a first and greatest pressure (psi) to selected ones of grippers 32 on the left side in FIG. 6, a second or intermediate pressure to selected intermediate grippers 32, and a third and lowest pressure to selected grippers 32 on the right side in FIG. 6. Advantageously, in this case, a relatively high pressure for a particular gripper 32 is provided in the vicinity of a relatively thick part of the bead apex 80, and therefore, these sections of the bead apex 80 may be held more securely. Conversely, a relatively low pressure for a particular gripper 32 is provided in the vicinity of a relatively thin part of the bead apex 80, and therefore, particular grippers 32 do not squeeze finer rubber portions of the bead apex 80 with an excessive and potentially damaging pressure, while allowing for some potentially desirable movement at this portion of the bead apex.

In either actuation technique, in the extended state, at least one of the plurality of grippers 32 engages a surface of the bead apex 80, such that the bead apex 80 is generally sandwiched between the engaging surface 42 of the lower jaw 40 and selected ones of the plurality of grippers 32 of the upper jaw 30, as depicted in FIG. 6.

Advantageously, at least one of the plurality of grippers 32 comprises a tapered end surface 38 that engages a tapered surface 86 of the bead apex 80 to enhance the engagement with the bead apex 80, as depicted in FIG. 6. In this manner, various triangular-shaped cross-sections of bead apices, such as the bead apex 80 depicted in FIG. 6, may be gripped by selected ones of the plurality of grippers 32, with a generally complementary mating of tapered surfaces, thereby providing an enhanced surface engagement between the grippers 32 and the bead apex 80. This may enhance contact across radial edges of the bead apex 80, particularly while the bead apex 80 is held while being applied to a bead ring.

Notably, a surface 87 of the bead apex 80, which generally opposes the tapered surface 86, may be generally flat and may engage the generally flat engaging surface 42 of the lower jaw 40, as depicted in FIG. 6. In this manner, a bead apex 80 having one generally flat side and one at least partially tapered side may be gripped by opposing jaws, where one jaw is generally flat and the other comprises at least one tapered gripper, thus providing a secure engagement on both sides of the bead apex. Due to a substantially flush fit between the at least one tapered gripper and the bead apex, the amount of deformation is reduced when a rubber surface is clamped, which may reduce markings on the final product.

It should be noted that only selected ones of the plurality of grippers 32 may be tapered, and the angle of the taper may be different among grippers 32. As best depicted in the retracted state of FIG. 4, in this non-limiting example, the first two grippers 32 from the left comprise generally flat surfaces that selectively engage the bead apex 80, while the third, fourth and fifth grippers 32 from the left comprise a relatively sharp taper, while the sixth gripper 32 from the left comprises a relatively shallow taper, and the seventh gripper 32 from the left comprises a relatively sharp taper.

As a further advantage, a user does not need to manually remove the grippers 32 for different tapered bead apex profiles, e.g., different triangular shapes when viewed in cross-section, in part because the blocking elements 39 can be selectively engaged to omit selected grippers 32 depending on different bead apex profiles. Rather, a user simply needs to select which of the plurality of grippers 32 should be actuated to best match a bead apex profile being gripped. Moreover, the gripping force at each gripper 32 can be varied, as discussed above, and therefore the grippers 32 are able to engage a tapered surface of different bead apices in a custom manner, all without removing the grippers 32.

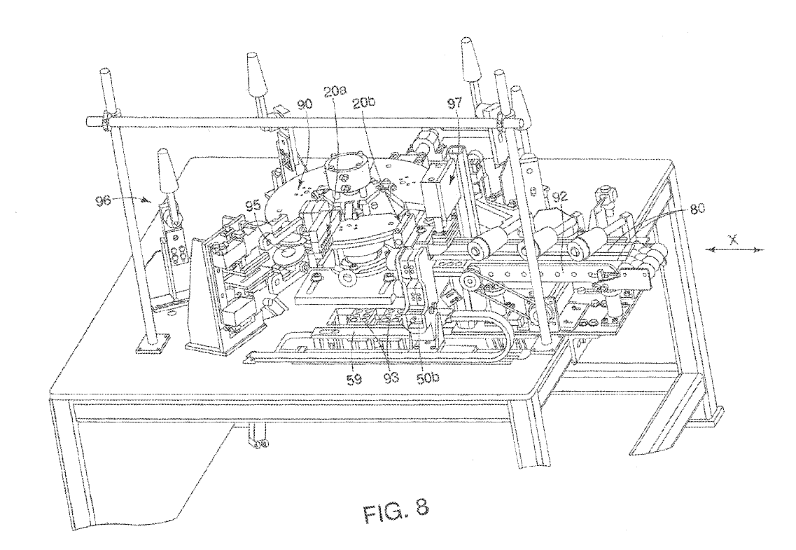

Referring now to FIG. 8, additional systems and methods are described that may be used in conjunction with the system 20 for gripping and handling a bead apex that was described in FIGS. 1-7 above. In FIG. 8, the additional systems generally assist in allowing a consistent application of the bead apex 80 to a bead ring that is held on a winder 90.

In this embodiment, a leading edge gripper 20a and a trailing edge gripper 20b are used to couple the bead apex 80 to a bead ring. Each of the leading edge gripper 20a and the trailing edge gripper 20b may be provided in accordance with the system 20 for gripping and holding a bead apex, as described in detail in FIGS. 1-7 above. It should be noted that the leading edge gripper 20a is generally secured to the winder 90 and rotates with the winder 90, while the trailing edge gripper 20b stands apart from the winder 90 and is capable of longitudinal movement along a conveyor axis X, as shown in FIG. 8.

In one exemplary method, an extruded bead apex 80 has a leading edge 81, best seen in FIG. 1, which is cut when unclamped and without stress. A conveyor 92, shown in FIG. 8, then advances the bead apex 80 for a determined distance in an unclamped state without stress. Then, in a next step, the lower jaw 40 of the trailing edge gripper 20b moves from the open state to the closed state to engage a lower surface of the bead apex 80. Subsequently, the upper jaw 30 of the trailing edge gripper 20b moves from the open state to the closed state, and selected ones of the plurality of grippers 32 of the trailing edge gripper 20b move from the retracted state to the extended state to engage an upper surface of the bead apex 80. At this time, the leading edge 81 of the bead apex 80 is secured within the trailing edge gripper 20 b, as generally shown in the manner depicted in FIG. 6 above.

In a next step, the trailing edge gripper 20b traverses towards the winder 90, e.g., by moving a frame 50b of the trailing edge gripper 20b longitudinally along a rail 59, in the direction X from right to left in FIG. 8. At the same time the trailing edge gripper 20b traverses towards the winder 90, the conveyor 92 is left on to reduce stresses and stretch of the bead apex 80 that may be incurred by the conveyor 92 moving slower than the trailing edge gripper 20 b. A ratio of speed of the trailing edge gripper 20b moving along the rail 59 to speed of the conveyor 92 may be adjusted to reduce imposition of stress to the bead apex 80.

As the trailing edge gripper 20b traverses towards the winder 90, one or more support tables 93 may be selectively deployed, from a lowered position shown in FIG. 8 to a raised position at a height approximate to the bead apex travel path, to provide support to the bead apex 80 as it travels in the longitudinal direction. The support tables 93 begin in a lowered position so they do not interfere with movement of the frame 50b and the lower jaw 40 of the trailing edge gripper 20b in a direction towards the winder 90, and once the trailing edge gripper 20b has passed the support tables 93, the tables 93 are raised to portions that support the bead apex 80 where it is suspended between the trailing edge gripper 20b and the conveyor 92.

When the trailing edge gripper 20b approaches a tangent point of a bead ring disposed on a periphery of the winder 90, the winder 90 begins to rotate. After the tangent point of the bead ring is reached, the trailing edge gripper 20b no longer moves longitudinally and the winder 90 is no longer rotated. With these components stationary, the lower jaw 40 of the leading edge gripper 20a moves from the open state to the closed state to engage a lower surface of the bead apex 80. Subsequently, the upper jaw 30 of the leading edge gripper 20a moves from the open state to the closed state, and selected ones of the plurality of grippers 32 of the leading edge gripper 20a move from the retracted state to the extended state to engage an upper surface of the bead apex 80. At this time, the leading edge 81 of the bead apex 80 is secured within the leading edge gripper 20 a, as generally shown in the manner depicted in FIG. 6 above. Further, at this time, the grippers 32 of the trailing edge gripper 20b are retracted, and the upper and lower jaws 30 and 40 of the trailing edge gripper 20b each move from the closed to open states, thereby freeing the bead apex 80 from engagement with the trailing edge gripper 20 b. The trailing edge gripper 20b then moves back towards its starting position, i.e., in a direction from left to right along the axis X via the rail 59.

In a next step, the winder 90 begins to rotate in a circumferential direction. Optionally, one or more additional support tables 53 may be deployed to further support the bead apex 80 as it is advanced by rotation of the winder 90.

The winder 90 then stops after the leading edge gripper 20a reaches a position beyond stitching wheels 95. In one example, stitching wheels 95 comprise upper and lower wheels, where the lower stitching wheel is raised and the upper stitching wheel is lowered during actuation. Once the upper and lower stitching wheels 95 are in contact with the bread apex 80, the winder 90 will resume circumferential rotation, as the conveyor 92 continues to feed the extruded bead apex 80. During this stage, the stitching wheels 95 are securing the bead apex 80 circumferentially about the bead ring. During the process, one or more anti-cup rollers 96, shown in FIG. 8, may be positioned or otherwise activated for support in order to keep the bead apex 80 from cupping. A ratio of speed of the leading edge gripper 20a moving about the winder 90 to speed of the conveyor 92 may be adjusted to reduce imposition of stress to the bead apex 80 while it is being advanced around the winder 90 and secured to the bead ring.

At a programmable and predetermined degree of rotation, the winder 90 will cease to circumferentially rotate in preparation for a cutting position. When the winder 90 stops, the conveyor 92 is operable to pay out a given amount of the bead apex 80, in order to remove potential stresses within the bead apex that has yet to be applied to the bead ring.

In a next step, the trailing edge gripper 20b is once again actuated to engage the bead apex 80 by closing the lower jaw 40 and then the upper jaw 30, and extending at least one of the plurality of grippers 32, as explained in detail above. At this time, a knife 97 is actuated to cut the bead apex 80 and create a trailing edge of the bead apex 80. It is noted that the cutting by the knife 97 occurs under minimal, if any, stress being applied to the bead apex 80. With the trailing edge gripper 20b movement temporarily halted, the winder 90 is rotated circumferentially a programmed number of degrees in order to re-tension to the bead apex 80, i.e., the leading edge of the bead apex 80 held by the leading edge gripper 20a is rotated circumferentially a distance while the trailing edge of the bead apex 80 held by the trailing edge gripper 20b is held stationary near the knife 97. Advantageously, this sequence of movement of components reduces the phenomena known as “dog-ear” bending, which may be undesirable.

Once the bead apex 80 is under tension, the winder 90 continues to move circumferentially while the trailing edge gripper 20b is then advanced along the rail 59, until a time that the leading edge gripper 20a and the trailing edge gripper 20b are in close proximity to one another, thereby aligning the leading and trailing edges of the bead apex 80. For illustrative purposes, referring to FIG. 8, at this time the trailing edge gripper 20b would be positioned slightly clockwise to the leading edge gripper 20 a. The seam between the leading and trailing edges of the bead apex 80 is then closed by application of appropriate pressure to one another. It is noted that, once the bases of the leading and trailing edges of the bead apex 80 are brought together, the trailing edge gripper 20b and the leading edge gripper 20a move in a synchronized manner towards one another, in order for the pressure-sensitive rubber of the bead apex to be joined together. Subsequently, the leading and trailing edge grippers 20a and 20b each release the bead apex 80 by moving from their respective closed to open states, thereby releasing the finished bead apex. The leading and trailing edge grippers 20a and 20b then may move back to their respective starting positions in order to assemble a subsequent extruded bead apex 80.

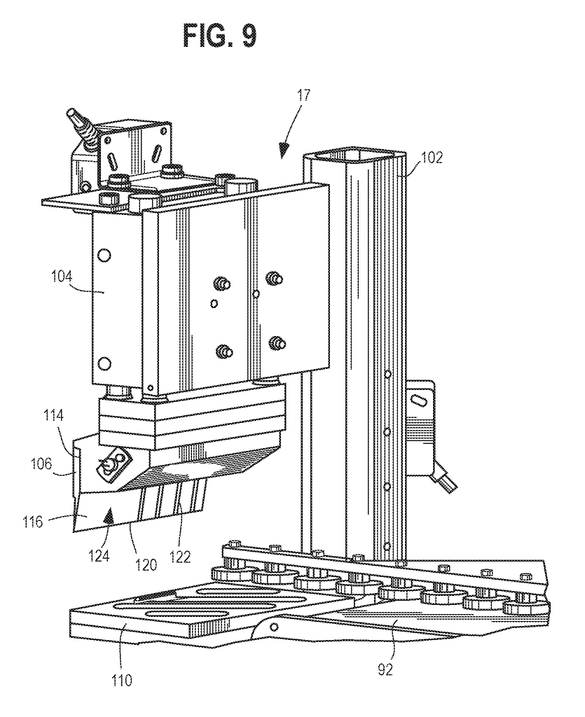

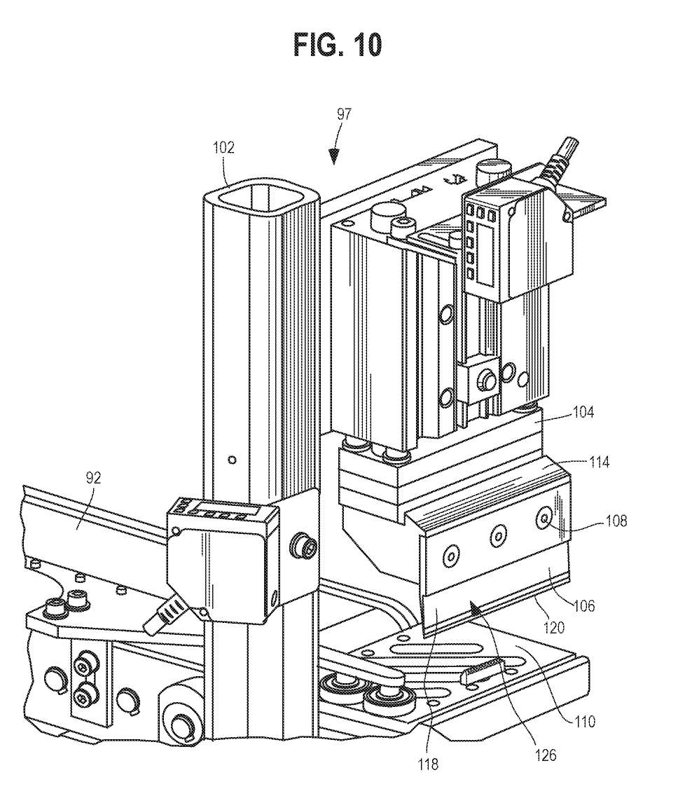

FIGS. 9-10 show opposite perspective views of one exemplary embodiment of the knife 97. As depicted, the knife 97 may generally include a frame 102 that secures a knife actuator 104 and a blade 106 above the conveyor 92. The knife actuator 104 may be mechanically coupled to the blade 106 (e.g., via screws 108 or another suitable connector). In particular, the knife actuator 104 may include a linear actuator (e.g., pneumatic, electric, etc.) for moving the blade 106 of the knife 97 towards and away from a cutting surface 110 located positioned for communication with the blade 106. A blade adapter 114 may connect the blade 106 with the knife actuator 104, and the blade adapter 114 may be capable of receiving different blades such that the blades are changeable. When a bead apex 80 (shown in FIG. 8) is located on a cutting surface 110, the vertical movement of the knife 97 may cause a cutting edge of the blade 106 to engage and cut through the bead apex 80 (FIG. 8). For example, this cutting operation may be performed when it is time to separate the above-described trailing edge of the bead apex 80 from the original extruded strip (and thus also forming a leading edge of a new, upstream bead apex). The blade 106 may have a first face 116 (shown in FIG. 9) facing upstream (e.g., towards the extruder) and a second face 118 (shown in FIG. 10) facing downstream (e.g., towards the winder 90 of FIG. 8), or vice versa. The first face 116 and the second face 118 may have surfaces that converge at the cutting edge 120. At least one of the first face 116 and the second face 118 may include one or more serrations 122.

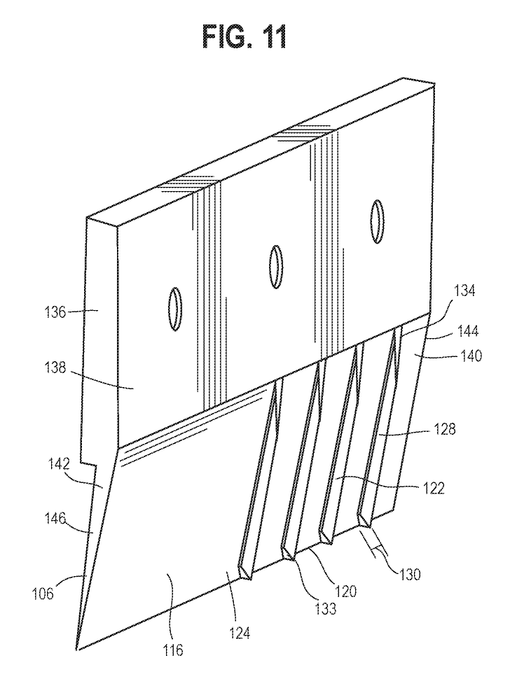

For example, referring to FIG. 11 (showing the blade 106 in isolation), the first face 116 of the blade 106 may have a first surface 124 extending from the cutting edge 120, where the serrations 122 extend from the first surface 124. In contrast, referring to FIG. 10, the second face 118 may have a second surface 126 and may lack serrations, therefore being substantially flat. The serrations 122 shown in FIG. 11 may be formed of elongated bumps, spikes, or other protrusions extending from the first surface 124 that function to form a grooved cut within an edge (e.g., trailing or leading edge) of the bead apex. While the serrations 122 can have any suitable cross-sectional shape, in the depicted embodiment, the serrations 122 each have a triangular profile with a 60 degree corner at the triangular apex (herein referred to as a “cornered apex”), and therefore form a serration edges 128. The cornered serration edges 128 may enhance the ability of the serrations 122 to form grooves within an edge of the bead apex, and it is contemplated that they could be further sharpened to amplify this feature.

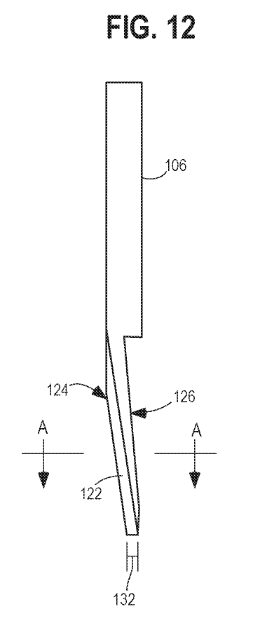

The serrations 122 may have a width 130 of between about 1/32″ and about ½″, such as about 1/16″. Herein, the “width” of the serrations 122 is the maximum dimension of the serrations 122 in the direction parallel to the cutting edge 120 of the blade 106. In comparison, the overall width of the blade 106 may be about 4″ in certain embodiments. Similarly, the serrations 122 may have a height of between about 1/32″ and about ½″, such as about 1/16″. The “height” of the serrations 122 is defined as the distance of the serration edge 128 to the underlying blade surface (in this case the first surface 124 of the blade 106). To illustrate, the height 132 of a serration 122 is shown in FIG. 12, which shows a side view of the blade 106 having the first face 116 and the second face 118. Any other suitable serration dimensions may be used, and the serrations 122 do not need to be the same size. FIG. 12 also shows that first surface 124 and the second surface 126 of the blade are on an incline (e.g., of about 5 degrees), but the incline is optional. An inclined blade 106 may be advantageous for leading/trailing edges with corresponding/compatible inclines (which may show better bonding characteristics than surfaces that are not inclined).

Referring back to FIG. 11, the serrations 122 may have a first end 133 (e.g., adjacent to the cutting edge 120), and may also have a second end 134. A length 136 of the serrations 122, measured from the first end 133 to the second end 134, may be about 1″, though larger or smaller serrations are also contemplated (e.g., from about ¼″ to about 3″). In non-limiting exemplary embodiments, the serrations 122 have a length that is at least as large as the maximum thickness of the bead apex. While not required in all embodiments, the serrations 122 may extend all the way across the first face 116 (e.g., from the cutting edge to an opposite edge 138), which may be advantageous for maximizing the serration length and/or for ease of manufacturing the blade 106. Optionally, at least one of the serrations 122 may have a different length than another one of the serrations 122.

In the depicted embodiment, four serrations 122 are included, but any suitable number may be provided (e.g., from one serration 122 to about ten, or more, serrations 122). The serrations 122 can have any suitable spacing (do not necessarily need to be spaced at equal distances), and more serrations 122 may be located on a first side 140 than on a second side 142. For example, in the depicted embodiment, the serrations 122 are spaced about ⅜″ from each other, and they are generally located closer to a first edge 144 of the blade 106 than an opposite second edge 146. This may be advantageous for concentrating grooves formed in a bead apex at the relatively thick areas, as described in more detail below.

The blade 106 may be heated, which may enhance its ability to form a clean cut (particularly when the bead apex formed of a material with a relatively low melting point). For example, the blade 106 may be heated to a temperature between about 100 C and about 300 C, such as between about 160 C and about 220 C in certain embodiments. A first heater (not shown) may provide heat through conduction into the blade material (e.g., a Teflon-coated steel or any other suitable material) to maintain this cutting temperature. When the serrations 122 are formed from the same material as the rest of the blade 106, the serrations 122 may also be heated to about the same temperature (thus enhancing their ability to form grooves in a bead apex). It is further contemplated that the serrations 122 may be formed of a different material that has a higher thermal conductivity than the material of the remainder of the blade 106, and thus the temperature of the serrations 122 may be higher than the temperature of the rest of the blade 106 to further enhance its groove-forming feature. When the serrations 122 are intended to cut with a different temperature than the rest of the blade 106, a second heater (not shown) may be included for providing heat to the serrations 122.

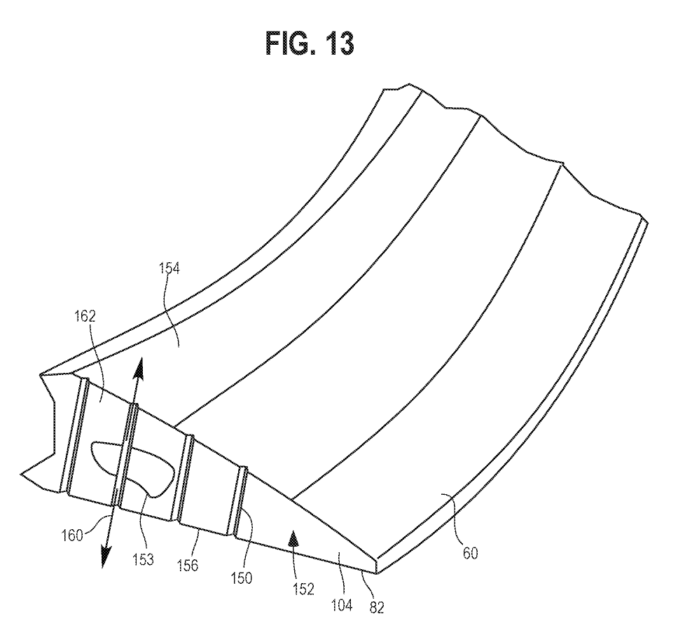

FIG. 13 shows a trailing edge 82 of the bead apex 80 after the trailing edge 82 is cut with the knife 97 described above. As shown, the trailing edge 82 of the bead apex 80 includes four grooves 150, which correspond to the four serrations 122 described with reference to FIGS. 9-12. Optionally, the grooves 150 shown in FIG. 13 may extend across the entire cross section of the trailing edge surface 152 from a first face 154 to a second face 156. In other embodiments, the grooves 150 may extend only partially through the cross section.

The grooves 150 provide a solution to a common problem that arises when forming bead apexes, namely the occurrence of trapped air between the trailing edge 82 and the leading edge (not shown in FIG. 13) of the bead apex 80 when those two edges are secured together at a splice. In particular, the grooves 150 provide an outlet from a potential air pocket 158, which represents otherwise-trapped air between the leading and trailing edges. To illustrate, if the air pocket is formed due to the trailing edge surface 152 (and/or leading edge surface) being slightly concave (which is a common occurrence after cutting due to the softness of the heated extruded bead apex material), air can flow out of the concave cavity through channels provided by the grooves 150, as shown by arrows 160, as the leading and trailing edges are pressed together.

In the depicted embodiment, a first area 164 of the bead apex 80 (e.g., corresponding to the outer perimeter when the bead apex 80 is in a vehicle tire) may have a first thickness, a second area of the bead apex 80 (e.g., corresponding to the inner perimeter when the bead apex 80 is in a vehicle tire) may have a second thickness, and the second thickness may be greater than the first thickness. Optionally, more serrations 122 may be located on the thicker area (second area 162) than the thinner first area 164. This may be advantageous because thicker portions of the bead apex 80 may be more prone to developing concave pockets, and thus more prone to trapping air.

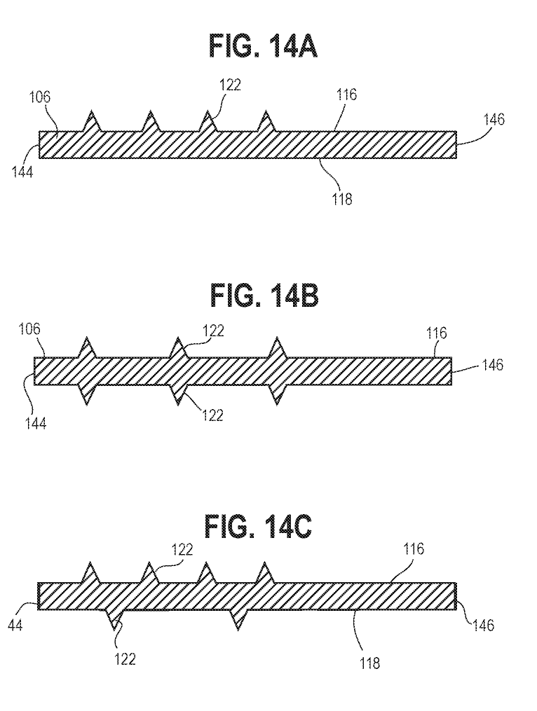

While the above-described embodiments generally have serrations on one face of a blade, and thus grooves on only one edge of the bead apex 80, other embodiments may incorporate a blade with serrations on more than one face. To illustrate, FIG. 14a, represents a top sectional view of the blade 106 shown in FIGS. 9-12 (along A-A of FIG. 12), where the serrations 122 extend from the first face 116, and where the second face 118 lacks serrations (but rather has a substantially flat surface from the first edge 144 to the second edge 146). However, in other embodiments, such as the embodiment of FIG. 14b, both the first face 116 and the second face 118 may have serrations 122. The result may be a bead apex having two splice surfaces (e.g., and the leading and trailing edges), where each splice surface has corresponding grooves. Further, the serrations 122 on each side may be substantially aligned, and each side may have the same number of serrations 122. Aligned grooves on opposite edges may enhance (e.g., enlarge) the resulting channel, thereby also enhancing the flowpath available to air that would otherwise be trapped. However, when serrations 122 are located on both faces of a blade, they do not need to be aligned in all embodiments, and a different number of serrations may be included on each face. In the embodiment of FIG. 14c, the serrations 122 of the first face 116 are offset with respect to the serrations 122 of the second face 118, and the first face 116 has more serrations 122 than the second face 118. The embodiments of FIGS. 14a-14c are included for illustration purposes only, and it is noted that many more embodiments are contemplated (e.g., serration patterns that differ in number, serration sizes, serration alignment, serration spacing, and the like).

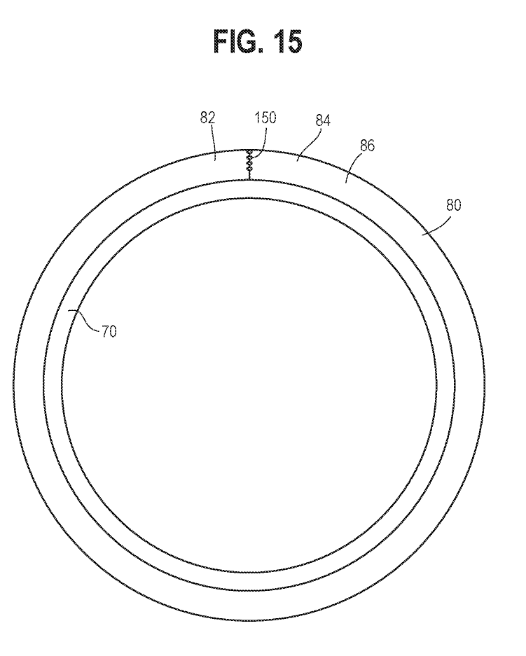

FIG. 15 shows a bead apex 80 connected to the outer perimeter of a bead 70 after formation on the winder 90 (described above with reference to FIG. 8). As shown, the bead apex 80 includes a splice 86 at the connection-point of the trailing edge 82 and a leading edge 84. The grooves 150 may extend through the bead apex 80 at the splice 86 at the completion of manufacturing, as shown. However, in other embodiments, the grooves 150 may not exist and/or may not be visible after the splice 86 is formed, particularly when the bead apex 80 is formed of a material that is compliant (at least when heated) such that the bead apex material fills the grooves when the leading edge 84 and the trailing edge 82 are pressed together.

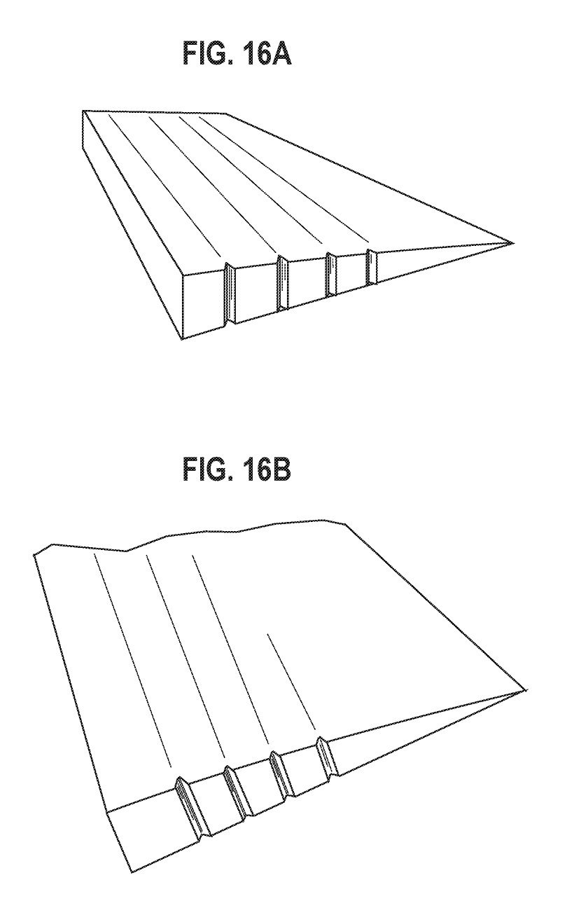

FIG. 16a-16b are photographs of a strips of extruded material cut with a blade in accordance with the blade 106 described with reference to FIGS. 9-12.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A knife for cutting a bead apex for a vehicle tire, the knife comprising:
a blade having a first face with a first surface;
a cutting edge located at an end of the first surface and positioned for engagement with the bead apex; and
a plurality of serrations extending from the first surface of the blade.

2. The knife of claim 1, wherein the serrations have a cornered apex configured to cut a groove in an extruded strip of material forming the bead apex.

3. The knife of claim 1, wherein the serrations extend at least 1/16″ from the first surface.

4. The knife of claim 1, further comprising a second face of the blade opposite from the first face, wherein the second face includes a second plurality of serrations.

5. The knife of claim 1, further comprising a second face of the blade opposite from the first face, wherein the second face is substantially flat.

6. The knife of claim 1, wherein each of the serrations extends to the cutting edge.

7. The knife of claim 1, wherein the first face includes a first side and a second side, and wherein the first side includes more serrations than the second side.

8. The knife of claim 1, wherein the first face is faced upstream with respect to a conveyor leading to a cutting surface beneath the blade.

9. A method comprising:
placing a bead apex on a cutting surface for communication with a blade of a knife,
the blade having a first face with a first surface, a cutting edge located at an end of the first surface and positioned for engagement with the bead apex, and a plurality of serrations extending from the first surface of the blade; and
cutting the bead apex with the knife.

10. The method of claim 9, further comprising forming a groove in the bead apex with at least one of the serrations.

11. The method of claim 10, further comprising forming a substantially flat splice surface with a second face of the knife.

12. The method of claim 10, wherein the groove is located on a surface at a trailing edge of the bead apex.

13. The method of claim 9, wherein the serrations have a cornered apex configured to cut a groove in an extruded strip of material forming the bead apex.

14. The method of claim 9, wherein the serrations extend at least 1/16″ from the first surface.

15. The method of claim 9, further comprising a second face of the blade opposite from the first face, wherein the second face includes a second plurality of serrations.

16. The method of claim 9, further comprising a second face of the blade opposite from the first face, wherein the second face is substantially flat.

17. The method of claim 9, wherein each of the serrations extends to the cutting edge.

18. The method of claim 9, wherein the first face includes a first side and a second side, and wherein the first side includes more serrations than the second side.

19. The method of claim 9, wherein the first face is faced upstream with respect to a conveyor leading to a cutting surface beneath the blade.

20. A vehicle tire, comprising:
an annular bead ring; and
a bead apex engaged with a peripheral surface of the annular bead ring,
wherein the bead apex includes a first edge with a first splice surface and a second edge with a second splice surface,
wherein the first splice surface and the second splice surface are coupled at a splice region, and
wherein a plurality of grooves extends through at least one of the first splice surface and the second splice surface to form a plurality of channels that extend through the splice region.
